(19) United States
(12) Patent Application Publication
(10) Pub. No.: US 2016/0371492 A1
(43) Pub. Date: Dec. 22, 2016

(54) METHOD AND SYSTEM FOR SEARCHING AND KILLING MACRO VIRUS

(71) Applicant: BEIJING QIHOO TECHNOLOGY COMPANY LIMITED, Beijing (CN)

(72) Inventor: Jiao LIU, Beijing (CN)

(21) Appl. No.: 14/901,477

(22) PCT Filed: Jun. 4, 2014
(86) PCT No.: PCT/CN2014/079169

§ 371 Date: Dec. 28, 2015

(30) Foreign Application Priority Data
Jun. 28, 2013 (CN) 201310268314.5

(51) Int. Cl. G06F 21/56; H04L 29/06

(52) U.S. Cl. CPC G06F 21/568; H04L 63/1425; G06F 21/566

(57) ABSTRACT

The present invention discloses a method and system for searching and killing a macro virus, which are applied in an enterprise edition virus searching and killing application. The method comprises: an enterprise edition client monitoring the operation of opening a document of a specific type, the document of a specific type comprising an office software document; when monitoring a request for opening a target document, intercepting the request and uploading the target document to an enterprise edition service end; the enterprise edition service end judging whether the target document contains a macro virus; and returning a processing instruction to the enterprise edition client according to the judgment result. By the method and system, the spreading of macro viruses inside an enterprise network can be withstood more effectively.

### FIELD OF THE INVENTION

The invention relates to the field of computer security technology, and in particular, to a method and system for searching and killing a macro virus.

### BACKGROUND OF THE INVENTION

A macro virus is one or more macro collection with the characteristics of a virus specially developed by a virus creator utilizing the openness of Microsoft Office, namely, BASIC programming interfaces provided in Office. Such a collection of virus macros can affect the use of a computer, and can be self-replicated and spread via a DOC document and a DOT template. Once a document infected with a macro virus is opened, its macro will be executed, and the macro virus will be activated, further move to the computer, and reside on the Normal template. Henceforth, all automatically saved documents will be “infected” with such a macro virus, and if other user opens a document infected with the virus, the macro virus will again move to his computer.

With the Microsoft modifying Office 97 and version above, most of the macro viruses based on the former Word versions can not be replicated, and the spread of the macro viruses is restrained. However, variants of the macro viruses begin to infect computers of users, and meanwhile, the infection range of the macro viruses transfers gradually from individual users to enterprise users, and the harm of the macro viruses to enterprises begins to stand out. The harm of a macro virus to an individual user is self-evident, it is highly invisible, and can spread rapidly and mutate easily, causes a user to be unable to use an office document normally, and very easily results in the harm that a document can not be written, a printer can not be used, a file can not be stored, and the like. However, relative to an individual user, a macro virus in an enterprise intranet is undoubtedly a greater disaster. Its harmfulness is generally characterized by the following several points.

Firstly, it is very easy for a macro virus to be spread in an intranet, and the difficulty in protecting against it is large. Circulation of an office file is one of the most common ways to communicate office data. Countless office files are spread from the superior to the grass-roots in a form like a pyramid, and there are constant interactions among the grass-roots. Such a flow of office files faithfully spreads and replicates the macro virus, and lets an IT administrator helpless.

Secondly, a macro virus can damage the key data in the intranet, thus causing the data in the intranet to suffer from serious damages and loose on a large scale, and it is difficult and time-consuming to recover it.

Thirdly, the cost of a variant of a macro virus is low and it poses a serious threat to the system. In most documents, a macro instruction is written using macro language Word Basic, and a macro virus is likewise written using Word Basic. The Word Basic language provides a number of system-level underlying invocations, for example, Dos, invocation of a Windows API, DLL, etc., and these operations can all pose a direct threat to the system. The detection function of a Word, Excel document with respect to the security and integrity of an instruction is very weak, and therefore, an instruction damaging the system can be executed easily. Yet for a macro virus generated by a new variant, an enterprise must upgrade protection software of the entire network uniformly so as to be able to protect against it timely, however, but this is not a simple thing for an administrator in the enterprise.

Besides, if an intranet is infected with a macro virus, it will cause the harm that a printer can not be used normally, devices in the intranet are cross-infected across platforms, and the like, and therefore, the prevention and treatment of macro viruses in an enterprise intranet is essential in the anti-virus policy of the entire enterprise.

An existing method for solving macro viruses inside an enterprise is to deploy searching and killing tools on clients in the intranet to search and kill, however, since the variation of a macro virus is extremely fast, if the variation speed of the macro virus is to be followed, a macro virus library needs to be updated at a higher speed, which causes the macro virus library saved on a terminal to become increasingly bulky and bloated, which will affect the searching and killing efficiency, and even finally affect the normal operation of the terminal system. In addition, if a terminal in the intranet can not be connected to the internet, it can be only connected to a management end for updating the macro virus library, the searching and killing efficiency is lower, and it can not rapidly withstand a varied macro virus. In brief, a more efficient way is needed to withstand the spreading of a macro virus inside an enterprise network.

### SUMMARY OF THE INVENTION

In view of the above problems, the present invention is proposed to provide a method and system for searching and killing a macro virus, which can overcome the above problems or at least partly solve the above problems, and can withstand macro viruses from spreading inside an enterprise network more effectively.

According to an aspect of the present invention, there is provided a method for searching and killing a macro virus, which is applied in an enterprise edition virus searching and killing application, wherein the enterprise edition virus searching and killing application comprises an enterprise edition sever installed on a computing device of an enterprise user management and control center and enterprise edition clients installed on enterprise user terminal devices, and uniform management of each user terminal device where the enterprise edition client is located is realized by the enterprise edition service end, the method comprising:

the enterprise edition client monitoring the operation of opening a document of a specific type, the document of a specific type comprising an office software document;

when monitoring a request for opening a target document, intercepting the request and uploading the target document to the enterprise edition service end;

the enterprise edition service end judging whether the target document contains a macro virus; and

returning a processing instruction to the enterprise edition client according to the judgment result.

According to another aspect of the present invention, there is provided a system for searching and killing a macro virus, which is applied in an enterprise edition virus searching ad killing application, wherein the enterprise edition virus searching and killing application comprises an enterprise edition service end installed on a computing device of an enterprise user management and control center and enterprise edition clients installed on enterprise user terminal devices, and uniform management of each user terminal device where the enterprise edition client is located is realized by the enterprise edition service end, the system comprising:

a monitoring unit located in the enterprise edition client and configured to monitor the operation of opening a document of a specific type, the document of a specific type comprising an office software document;

an uploading unit located in the enterprise edition client and configured to, when monitoring a request for opening a target document, intercept the request and upload the target document to the enterprise edition service end;

a judgment unit located in the enterprise edition service end and configured to judge whether the target document contains a macro virus; and

an instruction returning unit located in the enterprise edition service end and configured to return a processing instruction to the enterprise edition client according to the judgment result.

According to the method and system for searching and killing a macro virus of the present invention, when a document needs to be opened, the enterprise edition client can upload the document to the enterprise edition service end for searching and killing a macro virus, thus, a macro virus feature library does not need to be saved at the enterprise edition client, and a problem will not occur that the virus library is too bulky and bloated, causing the searching and killing efficiency to decrease. Moreover, the macro virus feature library saved at the enterprise edition service end can be updated timely, and thus, a new macro virus variant can be dealt with more timely, thus achieving a more comprehensive effect of searching and killing macro viruses. Moreover, since a single user can timely find out whether a macro virus exists in a file when operating the file, the spreading of a macro virus from one user to other users inside an enterprise network can be avoided, and the ability of withstanding a macro virus inside the enterprise network can be improved.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings,

FIG. 1 shows a flow chart of a method according to an embodiment of the present invention;

FIG. 2 shows a schematic diagram of a system according to an embodiment of the present invention;

FIG. 3 shows a block diagram of an intelligent electronic device for carrying out a method according to the present invention; and

FIG. 4 shows a schematic diagram of a storage unit for retaining or carrying a program code implementing a method according to the present invention.

### DETAILED DESCRIPTION OF THE INVENTION

In the following exemplary embodiments of the disclosure will be described in more detail with reference to the accompanying drawings. While the exemplary embodiments of the disclosure are shown in the drawings, it will be appreciated that the disclosure may be implemented in various forms and should not be limited by the embodiments set forth herein. Rather, these embodiments are provided in order for one to be able to more thoroughly understand the disclosure and in order to be able to fully convey the scope of the disclosure to those skilled in the art.

In the following exemplary embodiments of the disclosure will be described in more detail with reference to the accompanying drawings. While the exemplary embodiments of the disclosure are shown in the drawings, it will be appreciated that the disclosure may be implemented in various forms and should not be limited by the embodiments set forth herein. Rather, these embodiments are provided in order for one to be able to more thoroughly understand the disclosure and in order to be able to fully convey the scope of the disclosure to those skilled in the art.

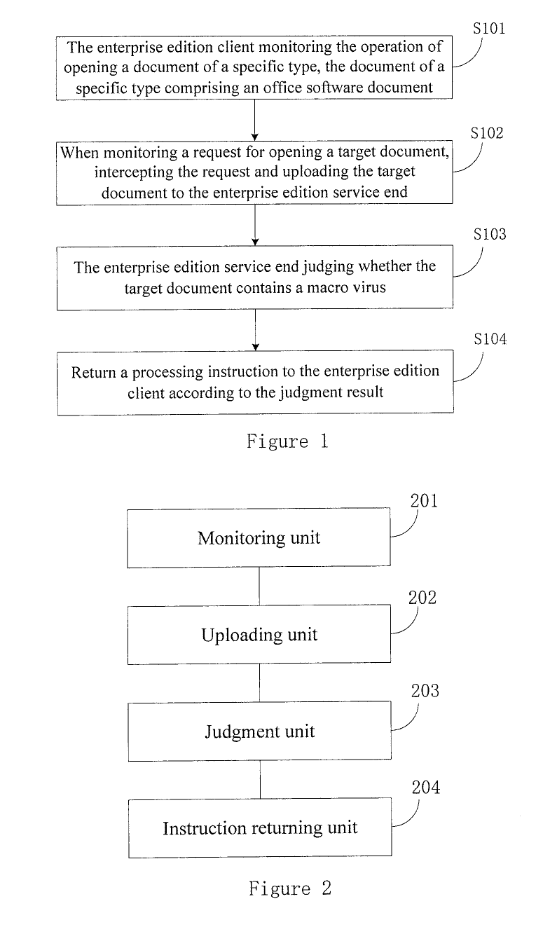

With reference to FIG. 1, an embodiment of the present invention provides a method for searching and killing a macro virus, which can be applied in an enterprise edition virus searching and killing application, wherein the enterprise edition virus searching and killing application comprises an enterprise edition service end installed on a computing device of an enterprise user management and control center and enterprise edition clients installed on enterprise user terminal devices, and uniform management of each user terminal device where the enterprise edition client is located is realized by the enterprise edition service end. That is to say, such enterprise edition virus searching and killing application amounts to form a “private cloud” inside the enterprise network, and the enterprise edition service end is equivalent to the server of the private cloud. As compared to a public cloud, the private cloud only serves the users of the enterprise intranet, and the enterprise network client can communicate with the enterprise network service through a local area network. Therefore, even if the enterprise network client is not connected to the internet, it can still use the enterprise network service end to obtain a required application or service. On the premise of deployment of the private cloud, the method comprises the following steps.

S101, the enterprise edition client monitors the operation of opening a document of a specific type, the document of a specific type comprising an office software document;

wherein the document of a specific type may comprise an office software document such as word, excel, etc. In the embodiment of the invention, it is not to perform the macro virus searching and killing of a full-disk scanning type, but to perform the macro virus searching and killing with respect to a certain document when a user wants to open the document. To this end, a hook function can be registered in the system in advance to HOOK API (Application Programming Interface) functions of the file edit type. As such, when a certain document is opened by invoking a corresponding API function, the invoked address will be forwarded to a macro virus searching and killing module provided by the present invention.

S102, when monitoring a request for opening a target document, the request is intercepted and the target document is uploaded to the enterprise edition service end.

After a request for opening a certain document is monitored, the request can be intercepted, that is, the request will not be sent to the address where the API function is located for the moment, but instead, security related processing will be performed first. In an embodiment of the invention, after the enterprise edition client intercepts the request for opening a document, it is not that the document is analyzed directly at the enterprise edition client locally, but that the document is directly uploaded to the enterprise edition service end, so as to perform specific analysis work at the enterprise edition service end. Therein, when deploying an enterprise edition security product, the address of the enterprise edition service end can be saved in each enterprise edition client. Therefore, after intercepting a request for opening a document, the corresponding document can be found out according to information such as a document path, etc. carried in the request, and uploaded to the enterprise edition service end according to the address of the enterprise edition service end.

It needs to be noted that, after intercepting a request for opening a document, since subsequent security analysis work needs a period of time, in this duration, the enterprise edition client can load and display a preset interface for displaying that macro virus detection is being performed.

S103, the enterprise edition service end judges whether the target document contains a macro virus.

After the enterprise edition service end receives the document uploaded by the enterprise edition client, it can judge whether the document contains a macro virus. Therein, in particular, when judging whether a document contains a macro virus, it can be judged according to some features common to macro viruses, for example, most macro viruses contain auto macro such as AutoOpen, AutoClose, AutoNew and AutoExit, etc., because only in this way, can a macro virus obtain control over document (template) operations. Further, some macro viruses control operations of a file by macros such as FileNew, FileOpen, FileSave, FileSaveAs, FileExit, etc. In addition, a virus macro inevitably contains macro instructions of read and write operations of a document, and a macro virus is stored in a .DOC document, a .DOT template in BFF (BinaryFileFormat) format, and the like.

In addition, in an embodiment of the invention, a feature extracting operation can be further preformed to a document, then, the extracted feature can be compared with features comprised in a preset feature library, and in turn whether a document contains a macro virus can be judged according to the comparison result. Therein, according to macro viruses' own features, it can be first judged whether a script file exists in a target document when extracting a macro virus from a document to be judged, and if no, it proves that no macro virus exists in the target document; and if a script file exists, a feature is extracted from the script, for example, contained string information, etc., and then compared with features in the feature library.

Therein, the features saved in the feature library can be features that belong to known macro viruses, that is, the feature library can be a blacklist, and as such, when the comparison is performed, if the feature extracted from the target document appears in the feature library, it proves that the target document carries a macro virus; and if the extracted feature does not appear in the feature library, it can be considered that no macro virus exists in the target document, or also it can be taken as unknown information to prompt a technician of the enterprise edition service end to perform further analysis and judgment, and the like. Or, features saved in the feature library can also be a whitelist, which can be regarded as a macro knowledge library. It records all the macros predefined by the system, and meanwhile, further allows a user to manually add a self-defined macro. As such, when a feature extracted from the target document is matched with features in the feature library, if the match is successful, then it proves that no macro virus exists in the target document, otherwise, if the match is unsuccessful, then it can be considered that a macro virus exists in the target document, or there might exist a macro virus, which prompt a technician to perform further analysis and judgment, or the like.

Therein, for various forms of feature libraries, when the enterprise edition service end is installed, a feature library with the newest version can be downloaded to the computer locality where the enterprise edition service end is located; whereas at a public cloud server end, after a new macro virus feature is obtained by analyzing a new macro virus variant, the feature library can be updated timely, and a macro virus searching and killing engine of the enterprise edition service end can connect the public cloud server regularly or irregularly to upgrade and update the feature library. Therein, in particular, when upgrading the feature library, a cover type or a increment type update method can be employed. That is to say, since the feature library itself is generally a file, when the enterprise edition service end needs to update the feature library, an entire feature library file with the newest version can be downloaded from the public cloud server, and the newly downloaded feature library file is used to cover the former feature library file. Or, it can also be that the current version is uploaded to the public cloud server, the public cloud server only returns the content in the newest version for which there exists update relative to the current version to the enterprise edition service end, and the enterprise edition service end then updates the former feature library file according to the data returned by the public cloud server, including adding a new feature, modifying an original feature, deleting an original feature, and so on.

It needs to be noted that, in the embodiment of the present invention, since the virus library is only saved on a computer where the enterprise edition service end is located, as long as the computer where the enterprise edition service end is located can connect the internet, the feature library can be upgraded and updated timely, and it is not needed for each enterprise edition client to perform download and update respectively, which is in favor of saving the bandwidth resource of an enterprise network.

S104, a processing instruction is returned to the enterprise edition client according to the judgment result.

After it is judged whether a macro virus exists in the target document, an instruction can be returned to the enterprise edition client. For example, if it is judged that no macro virus exists in the target document, then it proves that the target document is secure, therefore, an instruction of permitting the currently intercepted request pass can be returned directly, and thus, the request for opening a document will reach the original invocation address smoothly, to perform the operation of opening the document and a subsequent edit operation.

Yet, if it is judged that a macro virus exists in the target document, then it proves that the target document is insecure, and the macro virus existing in the target document can be eliminated to obtain a secure document and issue it to the enterprise edition client. Then, the instruction returned to the enterprise edition client can comprise information about the following several aspects: first, the currently intercepted request is discarded, that is, it is assured that the request for opening the original target document will not be executed, and meanwhile, the enterprise edition client is instructed to delete the original target document, replace it with the secure document after the macro virus is eliminated, and open the secure document. Thus, the result of the execution of the enterprise edition client is that: a document is opened by a user, such that the user can view the content in the document, and it is avoided to trigger a macro virus existing in the document originally, thus guaranteeing the security of the system.

It needs to be noted that, in particular, how to judge whether a document contains a macro virus and how to eliminate the macro virus in the document belong to methods in the traditional art, and will not be described in detail here.

In summary, in the embodiments of the invention, when a document needs to be opened, the enterprise edition client can upload the document to the enterprise edition service end for searching and killing a macro virus, thus, a macro virus feature library does not need to be saved at the enterprise edition client, and a problem will not occur that the virus library is too bulky and bloated, causing the searching and killing efficiency to decrease. Moreover, the macro virus feature library saved at the enterprise edition service end can be updated timely, and thus, a new macro virus variant can be dealt with more timely, thus achieving a more comprehensive effect of searching and killing a macro virus. Moreover, since a single user can timely find out whether a macro virus exists in a file when operating the file, the spreading of a macro virus from one user to other users inside an enterprise network can be avoided, and the ability of withstanding a macro virus inside the enterprise network can be improved.

Corresponding to the method for searching and killing a macro virus provided by the embodiment of the present invention, an embodiment of the present invention further provides a system for searching and killing a macro virus, which is applied in an enterprise edition virus searching and killing application, wherein the enterprise edition virus searching and killing application comprises an enterprise edition service end installed on an enterprise computing device of a user management and control center o and enterprise edition clients installed on enterprise user terminal devices, and uniform management of each user terminal device where the enterprise edition client is located is realized by the enterprise edition service end. Referring to FIG. 2, the system can comprise the following units:

a monitoring unit 201 located in the enterprise edition client and configured to monitor the operation of opening a document of a specific type, the document of a specific type comprising an office software document;

an uploading unit 202 located in the enterprise edition client and configured to, when monitoring a request for opening a target document, intercept the request and upload the target document to the enterprise edition service end;

a judgment unit 203 located in the enterprise edition service end and configured to judge whether the target document contains a macro virus; and

an instruction returning unit 204 located in the enterprise edition service end and configured to return a processing instruction to the enterprise edition client according to the judgment result.

When specifically implementing, according to the result of searching and killing, the instruction returning unit 204 may particularly comprise:

a first instruction returning subunit configured to return an instruction of permitting the request pass to the enterprise edition client if the judgment result is that the target document does not contain a macro virus.

Or, the instruction returning unit 204 may also comprise:

an elimination subunit configured to eliminate a macro virus in the target document to obtain a secure document if the judgment result is that the target document contains the macro virus; and

a second instruction returning subunit configured to return the secure document to the enterprise edition client and return an instruction of discarding the request, replacing the target document with the secure document and opening the secure document.

In a practical application, since the macro virus searching and killing procedure may need a period of time, after intercepting the request and before receiving the instruction returned by the enterprise edition service end, the apparatus may further comprise:

a display unit located at the enterprise edition client and configured to, after the request is intercepted, load and display a preset interface for displaying that macro virus detection is being performed.

When specifically implementing, the judgment unit 203 may comprise:

a feature extraction subunit configured to extract a feature from a script contained in the target document; and

a feature comparison subunit configured to compare the extracted feature with features saved in a preset macro virus library and judge whether a macro virus exists according to the comparison result.

In addition, the system may further comprise:

an update unit located at the enterprise edition service end and configured to connect a public cloud server so as to upgrade and update the macro virus library at the enterprise edition service end.

In summary, in the embodiments of the invention, when a document needs to be opened, the enterprise edition client can upload the document to the enterprise edition service end for searching and killing a macro virus, thus, a macro virus feature library does not need to be saved at the enterprise edition client, and a problem will not occur that the virus library is too bulky and bloated, causing the searching and killing efficiency to decrease. Moreover, the macro virus feature library saved at the enterprise edition service end can be updated timely, and thus, a new macro virus variant can be dealt with more timely, thus achieving a more comprehensive effect of searching and killing a macro virus. Moreover, since a single user can timely find out whether a macro virus exists in a file when operating the file, the spreading of a macro virus from one user to other users inside an enterprise network can be avoided, and the ability of withstanding a macro virus inside the enterprise network can be improved.

The algorithms and displays provided here are not inherently related to any specific computer, virtual system or other device. Various general-purpose systems may also be used with the teachings herein. According to the above description, the structure required for constructing such systems is obvious. In addition, the invention is not directed to any specific programming language. It should be understood that the content of the invention described herein may be carried out utilizing various programming languages, and that the above description for a specific language is for the sake of disclosing preferred embodiments of the invention.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination. Embodiments of the individual components of the invention may be implemented in hardware, or in a software module running on one or more processors, or in a combination thereof. It will be appreciated by those skilled in the art that, in practice, some or all of the functions of some or all of the components in a device for searching and killing a macro virus according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

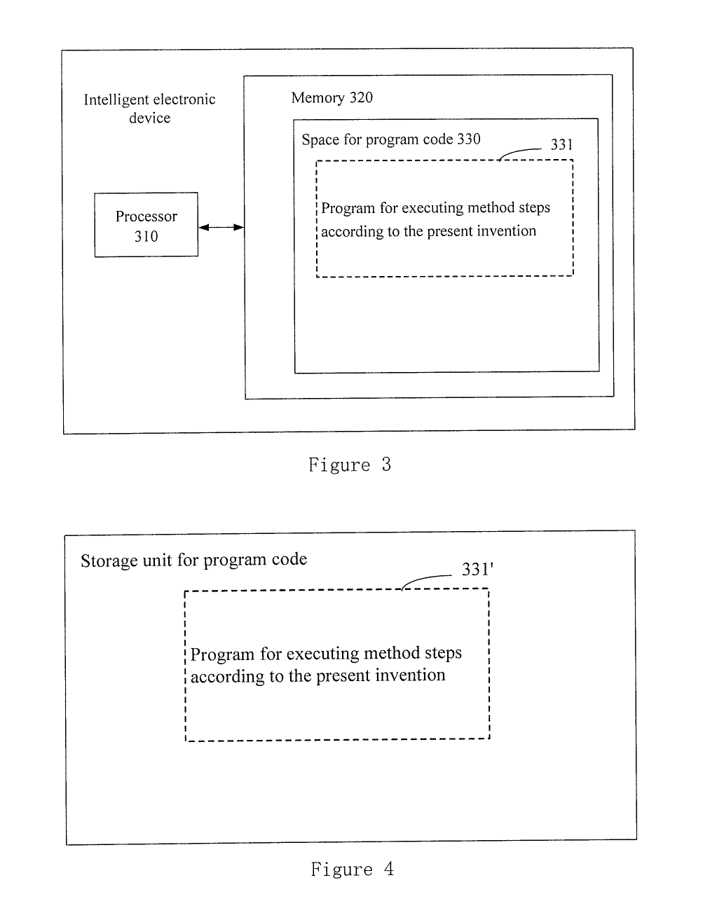

For example, FIG. 3 shows an intelligent electronic device which may carry out a method for a mobile terminal to process a visual graphics code according to the invention. The intelligent electronic device traditionally comprises a processor 310 and a computer program product or a computer readable medium in the form of a memory 320. The memory 320 may be an electronic memory such as a flash memory, an EEPROM (electrically erasable programmable read-only memory), an EPROM, a hard disk or a ROM. The memory 320 has a memory space 330 for a program code 331 for carrying out any method steps in the methods as described above. For example, the memory space 330 for a program code may comprise individual program codes 331 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 4. The storage unit may have a memory segment or a memory space, etc. arranged similarly to the memory 320 in the intelligent electronic device of FIG. 3. The program code may for example be compressed in an appropriate form. In general, the storage unit comprises a program 331′ for executing method steps according to the invention, i.e., a code which may be read by e.g., a processor such as 310, and when run by an intelligent electronic device, the codes cause the intelligent electronic device to carry out individual steps in the methods described above.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

1. A method for searching and killing a macro virus, applied in an application installed on both user terminal devices and service end for centralized management of each user terminal device, the method comprising:
the client monitoring the operation of opening a document of a specific type, the document of a specific type comprising an office software document;
when monitoring a request for opening a target document, intercepting the request and uploading the target document to the service end;
the service end judging whether the target document contains a macro virus; and
returning a processing instruction to the client according to the judgment result.

2. The method as claimed in claim 1, wherein the returning a processing instruction to the client according to the judgment result comprises:
returning an instruction of permitting the request pass to the client if the judgment result is that the target document does not contain a macro virus.

3. The method as claimed in claim 1, wherein the returning a processing instruction to the client according to the judgment result comprises:
eliminating the macro virus in the target document to obtain a secure document if the judgment result is that the target document contains a macro virus; and
returning the secure document to the client and returning an instruction of discarding the request, replacing the target document with the secure document and opening the secure document.

4. The method as claimed in claim 1, further comprising:
after the client intercepts the request, loading and displaying a preset interface for displaying that macro virus detection is being performed.

5. The method as claimed in claim 1, wherein the judging whether the target document contains a macro virus comprises:
extracting a feature from a script contained in the target document; and
comparing the extracted feature with features saved in a preset macro virus library and judging whether a macro virus exists according to the comparison result.

6. The method as claimed in claim 5, further comprising:
connecting a public cloud server so as to upgrade and update the macro virus library at the service end.

7. A system for searching and killing a macro virus, comprises an service end installed on a computing device of an user management and control center and clients installed on user terminal devices;
wherein, the user terminal devices comprises:
a memory having instructions stored thereon;
a processor configured to execute the instructions to perform following operations:
monitoring the operation of opening a document of a specific type, the document of a specific type comprising an office software document; and
when monitoring a request for opening a target document, intercepting the request and uploading the target document to the enterprise edition service end;
the computing device of the user management and control center comprises:
a memory having instructions stored thereon;
a processor configured to execute the instructions to perform following operations:
judging whether the target document contains a macro virus; and
returning a processing instruction to the client according to the judgment result.

8. The system as claimed in claim 7, wherein the returning a processing instruction to the client according to the judgment result comprises:
returning an instruction of permitting the request pass to the client if the judgment result is that the target document does not contain a macro virus.

9. The system as claimed in claim 7, wherein the returning a processing instruction to the client according to the judgment result comprises:
eliminating the macro virus in the target document to obtain a secure document if the judgment result is that the target document contains a macro virus; and
returning the secure document to the client and returning an instruction of discarding the request, replacing the target document with the secure document and opening the secure document.

10. The system as claimed in claim 7, the operations performed by the user terminal device further comprise:
after the request is intercepted, loading and displaying a preset interface for displaying that macro virus detection is being performed.

11. The system as claimed in claim 7, wherein the judging whether the target document contains a macro virus comprises:
extracting a feature from a script contained in the target document; and
comparing the extracted feature with features saved in a preset macro virus library and judging whether a macro virus exists according to the comparison result.

12. The system as claimed in claim 11, the operations performed by the computing device of user management and control center further comprise:
connecting a public cloud server so as to upgrade and update the macro virus library at the service end.

13. (canceled)

14. A non-transitory computer readable medium having instructions stored thereon that, when executed by at least one processor, cause the at least one processor to perform operations for searching and killing a macro virus, the operations comprising:
a client monitoring the operation of opening a document of a specific type, the document of a specific type comprising an office software document;
when monitoring a request for opening a target document, intercepting the request and uploading the target document to a service end;
the service end judging whether the target document contains a macro virus; and
returning a processing instruction to the client according to the judgment result.
